(19) United States
(12) Patent Application Publication
(10) Pub. No.: US 2018/0375141 A1
(43) Pub. Date: Dec. 27, 2018

(54) SELF-SUSTAINABLE SOLID OXIDE FUEL CELL SYSTEM AND METHOD FOR POWERING A GAS WELL

(71) Applicant: Saudi Arabian Oil Company, Dhahran (SA)

(72) Inventors: Ahmad D. Hammad, Dhahran (SA); Bandar A. Fadhel, Dhahran (SA); Stamatios Souentie, Dhahran (SA)

(73) Assignee: Saudi Arabian Oil Company, Dhahran (SA)

(21) Appl. No.: 15/723,664

(22) Filed: Oct. 3, 2017

Related U.S. Application Data
(60) Provisional application No. 62/523,838, filed on Jun. 23, 2017.

(51) Int. Cl. H01M 8/1253; H01M 8/0662

(52) U.S. Cl. CPC H01M 8/1253; H01M 2008/1293; H01M 8/0675

(57) ABSTRACT

Embodiments of a self-sustainable solid oxide fuel cell (SOFC) system for powering a gas well comprise a first SOFC comprising a first cathode, a first anode, and a first solid electrolyte; a second SOFC comprising a second cathode, a second anode, and a second solid electrolyte; SO₂ removal equipment; a combustion circuit comprising a combustor and a circulating heat carrier in thermal connection with the combustor, the first SOFC, and the second SOFC; and one or more external electric circuits. The first anode comprises a first oxidation region configured to produce SO₂ and electrons. The second anode comprises a second oxidation region configured to electrochemically oxidize CH₄ to produce syngas and electrons and electrochemically oxidize H₂ to produce H₂O and electrons. The external electric circuits are configured to generate power from the electrons produced in both the first SOFC and the second SOFC.

### BACKGROUND

### Field

Embodiments of the present disclosure generally relate to a solid oxide fuel cell (SOFC) system and, more specifically relate to a SOFC system which includes a first SOFC configured to remove hydrogen sulfide from sour natural gas and a second SOFC configured to generate electricity from the byproducts of the first SOFC.

### Technical Background

Power supply is a crucial requirement to sustain production and improve productivity for remote on-shore or off-shore natural gas wells. However, the accessibility of these wells to consistent and efficient power from traditional power sources is unsatisfactory. Many times it is unfeasible to run traditional power grid lines to the remote or off-shore locations of natural gas wells. Thus, the need to devise alternative power supply options to operate the various energy intensive applications within remote gas well locations is necessary. These applications include: wellhead gas compression, multiphase flow meters, remote terminal units, fire suppression systems, cathodic protection systems, supervisory control and data acquisition, and facility lights. The operation of the alternative power supply options many times requires transport of fuels to the remote location to operate the alternative power supply options.

Utilizing natural gas directly from the natural gas well as a fuel source is traditionally not feasible as the raw natural gas contains contaminants and other undesirable components such as hydrogen sulfide. As is conventionally known, a fuel cell consists of three major parts; an anode, where electrochemical oxidation takes place, a cathode, where electrochemical reduction takes place and the electrolyte membrane, which is a dense, gas impermeable, ion transport membrane which exhibits purely ionic or mixed ionic-electronic conductivity at a specific temperature range. Cathodes produce oxygen ions which then migrate through the electrolyte membranes to the anode electrode. The oxygen ions oxidize the fuel in the anode and thereby produce electrons, which flow through an external electrical circuit back to the cathode, thereby generating electrical energy. However, vulnerability to sulfur poisoning has been widely observed in SOFCs and thus the sulfur must be removed before entering the cell through the use of adsorbent beds or other means.

Accordingly, ongoing needs exist for self-sustainable solid oxide fuel cell systems which provide power to remote gas wells and are able to directly utilize the natural gas from the gas well as a fuel source.

### SUMMARY

Embodiments of the present disclosure are directed to a self-sustainable solid oxide fuel cell (SOFC) system and associated methods for powering a gas well. A first SOFC removes sulfur components from a natural gas feed stream and a second SOFC generates power with the byproducts of the first SOFC with each SOFC generating electrons, which are used to generate electricity. In essence, the present self-sustainable solid oxide fuel cell system is able to generate electricity in both the first and second SOFCs, and thus is considered as co-generating electricity. The generated electricity may then ultimately be utilized for the operation of the gas well itself. The systems of the present disclosure have industrial applicability, specifically in the Gas and Power industries due to the continuously increasing concentration of sulfur in natural gas reservoirs, and the enhanced demand for electricity in treatment plants and off-grid remote locations.

According to one embodiment, a self-sustainable solid oxide fuel cell (SOFC) system for powering a gas well is provided. The system comprises a first SOFC comprising a first cathode, a first anode, and a first solid electrolyte disposed between the first cathode and the first anode; a second SOFC comprising a second cathode, a second anode, and a second solid electrolyte disposed between the second cathode and the second anode fluidly connected to a first products stream from the first SOFC; SO₂ removal equipment in fluid communication with the first SOFC to remove SO₂; a combustion circuit comprising a combustor and a circulating heat carrier fluidly connected to a second products stream from the second SOFC; and one or more external electric circuits connected to the first SOFC and the second SOFC. The first anode comprises a first oxidation region configured to produce SO₂ and electrons from H₂S in a natural gas feed stream. The second anode comprises a second oxidation region configured to electrochemically oxidize CH₄ in the first products stream to produce syngas and electrons and electrochemically oxidize H₂ to produce H₂O and electrons. The circulating heat carrier is in thermal connection with the combustor, the first SOFC, and the second SOFC such that heat generated in the combustor from combustion of the at least second products stream is distributed to the first SOFC to maintain the first SOFC at a first operating temperature and distributed to the second SOFC to maintain the second SOFC at a second operating temperature, the first and second operating temperatures in excess of 700° C. The external electric circuits are configured to generate power from the electrons produced in both the first SOFC and the second SOFC.

In a further embodiment, a method for generating electricity from sour natural gas is provided. The method comprises providing a solid oxide fuel cell (SOFC) system comprising a first SOFC comprising a first cathode, a first anode, and a first solid electrolyte disposed between the first cathode and the first anode and a second SOFC comprising a second cathode, a second anode, and a second solid electrolyte disposed between the second cathode and the second anode fluidly connected to a first products stream from the first SOFC. The system also comprises SO₂ removal equipment in fluid communication with the first SOFC to remove SO₂, a combustion circuit comprising a combustor and a circulating heat carrier fluidly connected to a second products stream from the second SOFC, and one or more external electric circuits connected to the first SOFC and the second SOFC. The method further comprises feeding the sour natural gas to the first SOFC, producing SO₂ and electrons from H₂S in the sour natural gas at a first oxidation region of the first anode, and removing SO₂ from the system with the SO₂ removal equipment. Additionally, the method comprises feeding the first products stream from the first SOFC with the SO₂ removed to the second SOFC, electrochemically oxidizing CH₄ from the first products stream from the first SOFC in a second oxidation region of the second anode to produce syngas and electrons, and feeding the second products stream from the second SOFC to the combustion circuit and burning the syngas in the combustor to generate heat. The method also includes distributing the heat generated in the combustor to the first SOFC and the second SOFC via the circulating heat carrier, feeding a combustion product stream from the combustor to the second SOFC, and generating electricity with the one or more external electric circuits by collecting electrons generated in the first SOFC and the second SOFC.

Additional features and advantages of the embodiments described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a schematic illustration of a self-sustainable solid oxide fuel cell system in accordance with one or more embodiments of the present disclosure.

FIG. 2 is a schematic illustration of a self-sustainable solid oxide fuel cell system with a molten metal anode in accordance with one or more embodiments of the present disclosure.

### DETAILED DESCRIPTION

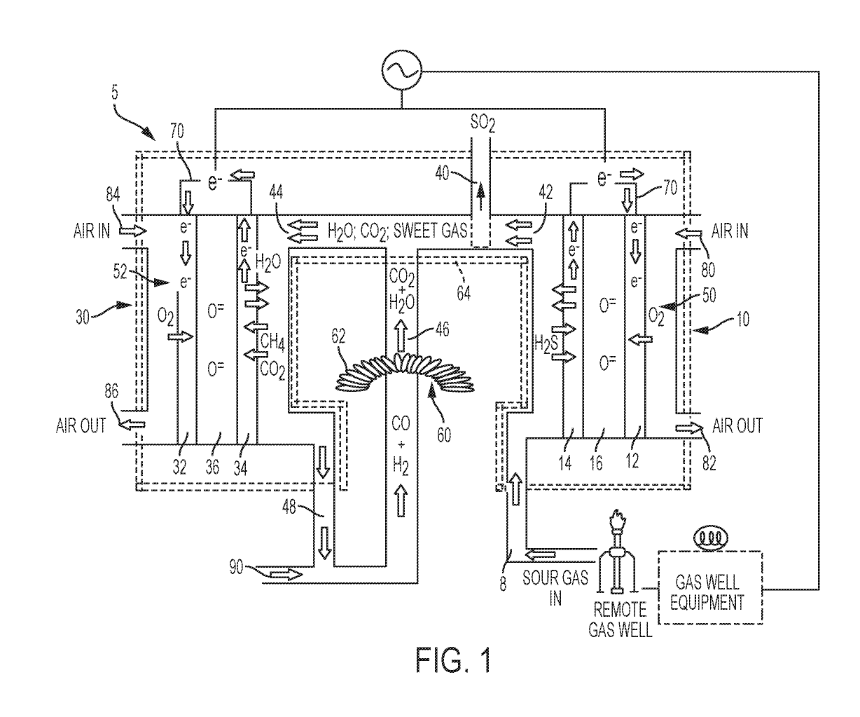

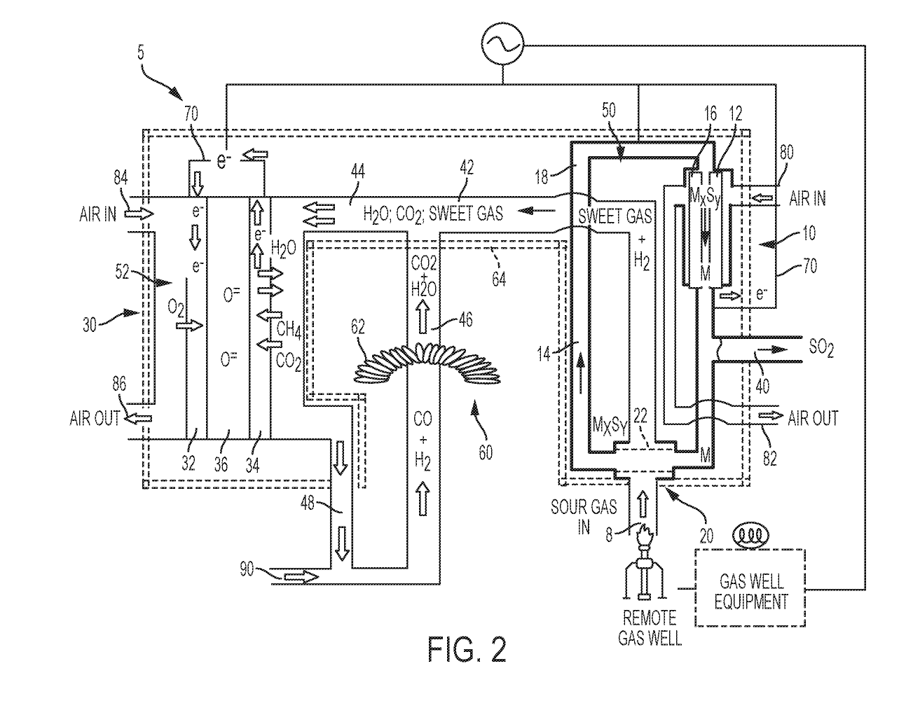

Reference will now be made in detail to embodiments of the self-sustainable solid oxide fuel cell system 5 of the present disclosure. Though the SOFC systems 5 of FIGS. 1 and 2 are provided as exemplary, it should be understood that the present systems and methods encompass other configurations.

The self-sustainable solid oxide fuel cell system 5 aims to provide a continuous and efficient electrical supply to operate equipment for remote on-shore or off-shore gas wells, where electricity supply is very limited. The system 5 provides a continuous and efficient electrical supply by integrating the utilization of solid oxide fuel cells (SOFCs) and steam and dry reformers by using the feed stream 8 from the remote gas well itself as the fuel source. Utilization of the feed stream 8 of natural gas directly from the remote well requires the consideration of the composition and constituents, especially hydrogen sulfide (H₂S), found in the natural gas produced in the well. There must be additional consideration as well for the efficiency and lifespan of the SOFCs by minimizing fouling of the SOFCs from impurities within the natural gas.

Natural gas composition varies from one well to another. However a typical composition of natural gas is indicated in Table 1. There are various constituents in natural gas beyond methane (CH₄) including ethane (C₂H₆), propane (C₃H₈), butane (C₄H₁₀), carbon dioxide (CO₂), oxygen (O₂), nitrogen (N₂), hydrogen sulfide (H₂S), and various trace amounts of rare gases (argon, helium, neon, and xenon). Of these various constituents found in natural gas, H₂S poses significant concern to the operation and integrity for the anode side of SOFCs. It is believed that the activity of Ni-based-anode SOFCs drops considerably after exposure to H₂S concentrations as small as 2 parts per million (ppm). Therefore, the system 5 includes H₂S-based SOFCs to generate electricity as well as “sulfur free” gas to be utilized in a subsequent hydrocarbon based SOFC with simultaneous steam and dry reforming.

TABLE 1
Typical composition of natural gas

| Constituent | Chemical Formula | Mole Percentage |
|---|---|---|
| Methane | CH₄ | 70-90% |
| Ethane | C₂H₆ | 0-20% |
| Propane | C₃H₈ | (total) |
| Butane | C₄H₁₀ | |
| Carbon Dioxide | CO₂ | 0-8% |
| Oxygen | O₂ | 0-0.2% |
| Nitrogen | N₂ | 0-5% |
| Hydrogen sulfide | H₂S | 0-5% |
| Rare gases | A, He, Ne, Xe | trace |

The disclosed system and methods provide a self-sustainable solid oxide fuel cell system 5 which includes a reformer and a combustor 62. The self-sustainable solid oxide fuel cell system 5 provides the necessary electricity to operate the various components of gas well preparation and operational equipment in off-grid and remote gas well sites. The system 5 utilizes a feed stream 8 of natural gas from the gas well itself as a fuel source, which is subsequently transformed, through embodiments of the disclosed self-sustainable solid oxide fuel cell system 5 and related methods, into electricity and heat. The generated heat maintains the operating temperature of the self-sustainable solid oxide fuel cell system 5 and the generated electricity powers the gas well operational equipment.

Referring to FIGS. 1 and 2, a self-sustainable solid oxide fuel cell (SOFC) system 5 for powering a gas well is shown. The system 5 comprises a first solid oxide fuel cell (SOFC) 10 and a second SOFC 30. As used herein, “first” is used to define components associated with the first SOFC 10 which produces electricity via the electrochemical oxidation of hydrogen sulfide or metal sulfides, whereas “second” is used to define components associated with the second SOFC 30 which produces electricity via electrochemical conversion of methane (CH₄) and hydrogen gas (H₂). The first SOFC 10 comprises a first cathode 12, a first anode 14, and a first solid electrolyte 16. The first solid electrolyte 16 is disposed between the first cathode 12 and the first anode 14. Similarly, the second SOFC 30 comprises a second cathode 32, a second anode 34, and a second solid electrolyte 36. The second solid electrolyte 36 is disposed between the second cathode 32 and the second anode 34. As used herein, “between” does not necessarily mean directly contacting, and contemplates that additional components are suitable between the anode, cathode, or electrolyte of each of the first SOFC 10 or second SOFC 30.

In operation, the first anode 14 of the first SOFC 10 comprises a first oxidation region 50 configured to produce SO₂ and electrons. Specifically, as discussed in detail subsequently in this disclosure, H₂S in a feed of sour natural gas 8 is ultimately converted to SO₂ through oxidation at the first anode 14. The mechanism of conversion from H₂S to SO₂ varies depending on the configuration of the first SOFC 10 and the type of anode utilized as the first anode 14. A solid metal anode directly converts H₂S to SO₂ and a molten metal anode converts H₂S to SO₂ via an intermediate of the metal sulfide of the molten metal forming the molten metal anode.

The second SOFC 30 also comprises an oxidation region in the form of a second oxidation region 52. The second oxidation region 52 is configured to electrochemically oxidize CH₄ to produce syngas and electrons and to electrochemically oxidize H₂ to produce H₂O and electrons.

The self-sustainable SOFC system 5 further comprises a combustion circuit 60. The combustion circuit 60 includes a combustor 62 and a circulating heat carrier 64. The combustion circuit 60 provides thermal energy in the form of heat to the first SOFC 10 and the second SOFC 30 to assist in maintaining the first SOFC 10 and the second SOFC 30 at optimal operating temperatures. The circulating heat carrier 64 is in thermal connection with the combustor 62, the first SOFC 10, and the second SOFC 30 such that heat generated in the combustor 62 is distributed to the first SOFC 10 to maintain the first SOFC 10 at a first operating temperature and distributed to the second SOFC 30 to maintain the second SOFC 30 at a second operating temperature. In one or more embodiments, the first operating temperature, the second operating temperature, or both are in excess of 700° C. In various further embodiments, the first operating temperature, the second operating temperature, or both are in the range of 700° C. to 1200° C., 700° C. to 1100° C., 700° C. to 1000° C., or 700° C. to 900° C. As a result of increased degradation rates and associated increased material costs incurred as the operating temperature is elevated, it is economically more favorable to operate a SOFC at the lowest temperature which provides sufficient electrolyte conductivity.

In embodiments, the circulating heat carrier 64 includes a fluid for carrying heat generated in the combustor 62 across the various components of the self-sustainable SOFC system 5. The fluid for carrying heat may be any gas, liquid, or flowable fine particles which can tolerate the elevated operating temperature of the combustor 62. In selecting the circulating heat carrier 64 at least the following parameters should be considered: coefficient of expansion of the circulating heat carrier 64, viscosity of the circulating heat carrier 64, and thermal capacity of the circulating heat carrier 64. The coefficient of expansion quantifies the fractional change in length, or volume when specified, of the circulating heat carrier 64 for a unit change in temperature. Consideration of the coefficient of expansion allows an appropriate circulating heat carrier 64 to be selected for the flow path of the circulating heat carrier 64. Similarly, viscosity quantifies the resistance of the circulating heat carrier 64 to sheer forces and the thermal capacity quantifies the ability of the circulating heat carrier 64 to store heat. Viscosity and thermal capacity determine the amount of pumping energy required to circulate the circulating heat carrier 64. A circulating heat carrier 64 with a lesser viscosity and a greater thermal capacity is easier to pump because it is less resistance to flow and transfers more heat. The stability and corrosiveness of the circulating heat carrier 64 should also be considered in selecting the circulating heat carrier 64.

The combustor 62 may comprise any conventional combustor that can handle syngas. Suitable combustors 62 for handling syngas would be known to one skilled in the art. Without wishing to be limited, an example combustor 62 may be a CAN combustor. Heat is generated in the combustor 62 with combustion of a fuel, such as syngas, and transferred to the circulating heat carrier 64.

Moreover, as shown in FIGS. 1 and 2, the SOFC system 5 comprises one or more external electric circuits 70, which collect electrons from the first SOFC 10 and the second SOFC 30 to generate electricity. The external electrical circuit 70 may comprise a wire, or any other electron conducting material that is solid and inert at the operating conditions. The external electric circuit 70 facilitates collection of the electrons which travel from the first anode 14 back to the first cathode 12 or second anode 34 back to the second cathode 32 via electrical circuit 70. While separate external circuits are contemplated for each SOFC, it is also contemplated that the first SOFC 10 and the second SOFC 30 may share the external circuits used in the co-generation of electrical energy. As used herein, “co-generation” is the collection of electricity from the first SOFC 10 and the second SOFC 30. While “co-generation” is often used in the literature to denote that chemicals and electricity are produced simultaneously in a fuel cell, it is used herein to represent the dual collection of electricity in the first SOFC 10 and the second SOFC 30.

In operation, as shown in FIGS. 1 and 2, the first cathode 12 reduces the O₂ in the first inlet air stream 80 in accordance with the following reaction (R1):

O₂(g)+4e⁻→2O²⁻ (R1)

The first SOFC 10 may operate in multiple configurations. In at least one embodiment, the first SOFC 10 operates with ex-situ SO₂ removal with an H₂S-based SOFC with a solid metal anode. Specifically, the first SOFC 10 may electrochemically convert H₂S from the fuel stream 8 into SO₂ and then, subsequent to the first SOFC 10, the generated SO₂ is removed from the first products stream 42 of the first SOFC 10. In at least one further embodiment, the first SOFC 10 operates with in-situ SO₂ removal and comprises a molten metal anode to form a molten metal anode solid oxide fuel cell (MMA-SOFC). Specifically, the first SOFC 10 may comprise a molten metal anode and convert H₂S from the natural gas fuel stream 8 to a metal sulfide and then electrochemically convert the metal sulfide into SO₂ for removal within the circulating flow of the molten metal anode 14.

In embodiments with the solid metal anode and ex-situ SO₂ removal, as illustrated in FIG. 1, the self-sustainable solid oxide fuel cell system 5 includes a two-stage reaction system to utilize a sour gas stream 8 directly from the wellhead of a natural gas well. In the first stage, the first SOFC 10 utilizes selective solid metal anodes 14 to remove H₂S present in the sour gas stream 8 via electrochemical oxidation. The first products stream 42 from the first SOFC 10 is then fed to the second SOFC 30 in the second stage. The second SOFC 30 then oxidizes the remaining fuel species in the first products stream 42 from the first SOFC 10 to generate additional electricity.

In the first SOFC 10, a sour gas stream 8 comprising H₂S from the wellhead of the natural gas well is utilized as a fuel. Specifically, the first SOFC 10 utilizes hydrogen sulfide within the sour gas 8 by performing the oxidation of H₂S into SO₂ via electrochemical means. H₂S has an elevated chemical potential where the energy is released to electricity at efficiencies of up to 80%. The electrochemical oxidation of H₂S in the first SOFC 10 begins with the reaction of H₂S from the sour gas 8 and migrated oxide ions from the first solid electrolyte 16 of the first SOFC 10. The migrated oxide ions are provided from the first inlet air stream 80. Additionally, additionally the removal of the oxygen from the first inlet air stream 80 produces an oxygen depleted first outlet air stream 82. The reaction of H₂S and the oxide ions can lead to two probable reactions in accordance with the following reactions (R2) and (R3):

H₂S+O²⁻→H₂O+½ S₂+2e- E°=0.742 V at 750° C., 1 atm (R2)

H₂S+3O²⁻→H₂O+SO₂+6e- E°=0.758 V at 750° C., 1 atm (R3)

The reaction of migrated oxide ions and H₂S in the first SOFC 10 produces sulfur (S₂), sulfur dioxide (SO₂), water (H₂O), heat, and electricity. The reaction products of a H₂S fueled SOFC system, such as the first SOFC 10, may be directed toward SO₂ generation with a commensurate reduction in S₂ generation by preferencing reaction (R3). The oxidation products from SOFCs such as the first SOFC 10 which are fueled by H₂ and H₂S are dictated by the flux of oxide ions from the cathode 12 reaching the anode 14. This ion flux is directly related to the level of fuel utilization in the system 5 with high fuel utilization levels favoring SO₂ production and low fuel utilization levels favor the production of elemental sulfur. For purposes of this disclosure, fuel utilization greater than 60% conversion may be considered as high fuel utilization.

The elevated operating temperatures of the first SOFC 10 may also result in the H₂S thermally decomposing. At temperatures in excess of approximately 700° C., H₂S may partially decompose into sulfur and hydrogen in accordance with the following reaction (R4):

H₂S→½ S₂+H₂ (R4)

The elemental sulfur and hydrogen produced by (R4) may further react in the electrochemical reactions of the first SOFC 10. Specifically, hydrogen and oxygen may react to produce water and electricity. Further, elemental sulfur and oxygen may react to produce SO₂ and electricity. These reactions are in accordance with the following reactions (R5) and (R6), respectively:

H₂+O²⁻→H₂O+2e- E°=1.185 V (R5)

½ S₂+2O²⁻→SO₂+4 e- E°=0.883 V (R6)

The resultant of the combinations of reactions (R1), (R2), (R3), (R4), (R5), and (R6) is removal of H₂S from the sour gas 8 with a resulting conversion to H₂O and SO₂ in the first SOFC 10. The SO₂ may be subsequently removed from the first products stream 42 before passage to the second SOFC 30 as a sweetened gas stream. The first products stream 42 from the first SOFC 10 includes sweet gas and H₂O, as well as SO₂ generated from the converted H₂S. Sweet gas is natural gas that contains very little or no hydrogen sulfide, specifically less than 20 ppm H₂S. In various embodiments, the sweet gas contains less than 20 ppm H₂S, less than 10 ppm H₂S, less than 1 ppm H₂S, less than 0.1 ppm H₂S, or less than 0.01 ppm H₂S.

In embodiments with in-situ SO₂ removal, as illustrated in FIG. 2, the self-sustainable solid oxide fuel cell system 5 also includes a two-stage reaction system to utilize a sour gas stream 8 directly from the wellhead of a natural gas well. In the first stage, the first SOFC 10 comprises a molten metal anode solid oxide fuel cell (MMA-SOFC) to manage H₂S and generate electricity by ultimately converting the H₂S to SO₂ for removal in the first products stream 42. The first products stream 42 from the first SOFC 10 is then fed to the second SOFC 30 in the second stage. The second SOFC 30 then oxidizes the remaining fuel species in the first products stream 42 from the first SOFC 10 to generate additional electricity.

A MMA-SOFC is a fuel cell where the metal anode is in the liquid or molten state. In operation, the molten metal anode is electrochemically oxidized by oxygen ions at the interface with the solid electrolyte. The molten metal anode is oxidized in accordance with generalized reaction (R7). In a standard MMA-SOFC, the produced molten metal oxide diffuses in the molten metal anode towards the interface with the fuel, where it oxidizes the fuel and is reduced back to the molten metal state in accordance with reaction (R8) in a looping cycle.

xM(1)+yO²⁻→MₓO_{y}(1)+2ye⁻ (R7)

aMₓO_{y}(1)+bCₘHₙ→cM(1)+dCO₂+eH₂O+fH₂ (R8)

The sour gas 8 fed to the first SOFC 10 in accordance with the present disclosure includes H₂S. Passage of the sour gas with H₂S through the first anode 14 (molten metal anode) generates molten metal sulfide and H₂ at the molten metal anode and gaseous fuel interface in accordance with reaction (R9).

xM(1)+yH₂S(g)+→MₓS_{y}(1)+yH₂(g) (R9)

The generated molten metal sulfide has a distinct density from the molten metal of the molten metal anode 14. Due to density difference between the molten metal of the first anode 14 and the molten metal sulfide, the molten metal sulfide diffuses towards the gravitational top of the melt. The molten metal sulfide forms a stream which comes into contact with the first solid electrolyte 16 and is electrochemically oxidized. The electrochemical oxidation of the molten metal sulfide regenerates the molten metal forming the molten metal anode 14 and produces SO₂ in accordance with reaction (R10) as well as electricity generation.

MₓS_{y}(1)+2yO²⁻∝xM(1)+ySO₂(g)+4ye⁻ (R10)

Referring to FIG. 2, in additional embodiments, it may be desirable to include a sulfation region 20 in the first SOFC 10. As used herein, “sulfation region” encompasses the contact area of the first molten metal anode 14 and the sulfur-containing sour gas 8 to further produce metal sulfides, which may then be electrochemically oxidized to generate electricity. This sulfation may occur in a fuel contactor 22, which may be adjacent the first solid electrolyte 16 and first cathode 12 (not shown) or separate from, but in fluid communication with, the first solid electrolyte 16 and first cathode 12 as depicted in FIG. 2. As described previously, these metal sulfides may be electrochemically oxidized in-situ to further generate electricity. The fuel contactor 22 may include porous tubing, for example ceramic or metallic, which will only allow for fuel diffusion towards the first molten metal anode 14, but will not allow the first molten metal anode 14 to escape.

As shown in FIG. 2, in the configuration with a molten metal anode for the first anode 14 there is a molten metal conduit 18 configured to deliver molten metal in the form of the first anode 14 between the sulfation region 20 and the first oxidation region 50 in a closed loop configuration. The sulfation region 20 is disposed in the molten metal conduit 18. The first oxidation region 50 is formed from the first solid electrolyte 16 and the first cathode 12. Various embodiments are contemplated for the molten metal conduit 18, for example, piping or tubing. While not specifically shown, the molten metal conduit 18 may include valves, pumps, or any other suitable device which aids or regulates the flow of the molten metal of the first anode 14.

During processing of the raw sour gas 8 in the first SOFC 10, the molten metal anode and the generated metal sulfide are circulated from the sulfation region 20 to the first oxidation region 50 of the first SOFC 10. The metals selected for the molten metal of the first anode 14 should account for the melting temperature of their metallic and sulfide phases. Both the metallic and sulfide phases must have melting temperatures within or below the fuel cell operating temperature range to avoid any precipitation phenomena. Further, the density of the metallic and sulfide phases and geometry of the first oxidation region 50 should be accounted for to ensure the metallic sulfide is properly exposed to the first solid electrolyte 16 for conversion back to the metallic phase and SO₂.

In various embodiments, multiple compositions are contemplated for the molten metal of the first anode 14. For example, and not by way of limitation, the first anode 14 may comprise metal selected from the group consisting of tin (Sn), bismuth (Bi), indium (In), lead (Pb), antimony (Sb), copper (Cu), molybdenum (Mo), mercury (Hg), iridium (Ir), palladium (Pd), rhenium (Re), platinum (Pt), silver (Ag), arsenic (As), rhodium (Rh), tellurium (Te), selenium (Se), osmium (Os), gold (Au), germanium (Ge), thallium (Tl), cadmium (Cd), gadolinium (Gd), chromium (Cr), nickel (Ni), iron (Fe), tungsten (W), cobalt (Co), zinc (Zn), vanadium (V), and combinations thereof. In an exemplary embodiment, the first anode 14 may comprise antimony. As shown below in Table 2, antimony is a suitable choice, because its melting points are relatively uniform whether antimony is in the form of a metal, an oxide, or a sulfide.

TABLE 2

Phase

| | |
|---|---|
| metallic | sulfide |

| | |
|---|---|
| Metal | Melting point, ° C. |

| | | |
|---|---|---|
| Sb/Sb₂S₃ | 630 | 550 |
| Sn/SnS | 232 | 882 |
| Bi/Bi₂S₃ | 271 | 775 |
| Tl/Tl₂S | 304 | 448 |

As described, the molten metal serves as a sulfur carrier and capturing agent and as the first anode 14 of the first SOFC 10. However, in the case of small electrocatalytic activity a conventional solid porous metal/metal oxide anode may be used additionally to further enhance the electrochemical oxidation rate. Small electrocatalytic activity is determined as the case with an asymmetric charge transfer coefficient. While various configurations are contemplated, the conventional solid porous metal/metal oxide anode may be disposed adjacent the first solid electrolyte 16 so as to separate the first solid electrolyte 16 and the first molten metal anode 14. In operation, the metal sulfide species should be oxidized electrochemically by oxygen ionic species supplied from the first solid electrolyte 16, producing electricity and SO₂(g).

Various metals suitable for oxidation may be utilized in the conventional solid porous metal/metal oxide anode, for example, a metal or ceramic-metallic. In one embodiment, the conventional solid porous metal/metal oxide anode comprises a metal or ceramic-metallic material with lower susceptibility to sulfation, that is a less stable metal sulfide than the metal of the molten metal anode. For example, iron (Fe), cobalt (Co), nickel (Ni), copper (Cu) and combinations thereof may be utilized for the conventional solid porous metal/metal oxide anode. In another embodiment, the conventional solid porous metal/metal oxide anode may use iron (Fe), and antimony (Sb) may be used in the molten metal of the first anode 14. Other compositional combinations of the conventional solid porous metal/metal oxide anode and the first molten metal anode 14 are also within the scope of the present disclosure.

Metal oxides may also be formed electrochemically from the first molten metal anode 14, in parallel with oxidation of the metallic sulfides back to molten metal. If metal oxide species are undesirable in the melt, then a sacrificial reducing agent (SRA) (not shown) may be used downstream of the first SOFC 10 in the molten metal conduit 18. In one embodiment, the SRA may be a graphite rod, acting to reduce metal oxide species to metal and CO₂, or a metal (in solid phase) with higher susceptibility to oxidation than the metal of the first molten metal anode 14. In embodiments where the SRA is a graphite rod, the SRA may have an adjacent opening to purge CO₂ from the system 5. A measure for susceptibility to oxidation of metals can be the metal oxide formation free energy, thus in the case of a Sb molten metal anode, the metal of the SRA could be one of the group comprising iron (Fe), zirconium (Zr), manganese (Mn), tantalum (Ta), silicon (Si) or titanium (Ti) and combinations thereof. This part will have a limited lifetime and is intended to be replaced when fully oxidized.

The SO₂ generated from the conversion of the H₂S to SO₂ in the first SOFC 10 with either a solid metal anode or molten metal anode may be removed from the first products stream 42 of the first SOFC 10. SO₂ removal equipment may be included downstream of the first SOFC 10. Example SO₂ removal equipment 40 utilized to remove the SO₂ from the product stream of the first SOFC 10 may include one or more units such as a wet scrubber unit, a spray-dry unit, a wet H₂SO₄ processing unit, a SNOₓ flue-gas desulfurization unit, and combinations thereof. Additionally, with a solid metal anode for the first anode 14, the SO₂ may be separated from the gaseous product stream of the first SOFC 10 with a separating column or membrane. Example membranes include ionic liquid membranes and hollow fiber composite membranes. In at least one embodiment with a molten metal anode, the produced SO₂ may be removed from the molten metal anode as gas bubbles downstream of the first solid electrolyte 16 and the first cathode 12. The SO₂ formed as gas bubbles may be collected by an external vent, as shown in FIG. 2. In at least one embodiment, the SO₂ removal equipment 40 is disposed in the molten metal conduit 18 between the first solid electrolyte 16 and the sulfation region 20 in the flow of the molten metal first anode 14.

In both embodiments with in-situ SO₂ removal and embodiments with ex-situ SO₂ removal, the sweet gas, which is substantially sulfur free after removal of the SO₂ from the first products stream 42, from the first SOFC 10 is provided to the second SOFC 30 as a second SOFC feed 44. The second SOFC feed 44 undergoes combined parallel chemical and electrochemical conversion at the second SOFC 30 to cogenerate electricity and synthetic gas (Syngas).

Chemical conversions occur at the second anode 34 of the second SOFC 30 as dry and steam reforming of the sweet gas in the second SOFC feed 44 in accordance with reactions (R11) and (R12), respectively. The reforming may occur within the second SOFC 30 or may be completed in a separate reformer unit (not shown) prior to introduction to the second SOFC 30. H₂O and CO₂ are fed into the second SOFC 30 as traces in the first products stream 42 and other products provided from the first SOFC 10 as well as a combustion product stream 46 comprising combustion products from combusting Syngas produced in the second SOFC 30 and passed through the combustor 62.

CO₂(g)+CH₄(g)→2CO(g)+2H₂(g) (R11)

H₂O(g)+CH₄(g)→CO(g)+3H₂(g) (R12)

The first products stream 42 from the first SOFC 10 undergoes electrochemical reactions in the second SOFC 30. The electrochemical reactions at the second anode 34 of the second SOFC 30 convert the CH₄ from the sweet gas in the second SOFC feed 44 into syngas (CO and H₂) in accordance with reaction (R13). Additionally, hydrogen gas from the first SOFC 10, the combustor 62, or both is reformed into water with oxygen at the second anode 34 in the second SOFC 30 in accordance with reaction (R14). The oxygen is provided from a second inlet air stream 84. Residual gas from the second inlet air stream 84 after oxygen removal is exhausted as outlet air stream 86. Reactions (R13) and (R14) additionally generate electricity along with the syngas and water, respectively.

CH₄(g)+O²⁻(el)→CO(g)+2H₂(g)+2e⁻ (R13)

H₂(g)+O²⁻(el)→H₂O(g)+2e⁻ (R14)

In detail, as shown in reaction (R11), CO₂(g) reacts with CH₄(g) which are co-fed to the second anode 34 (fuel side) of the second SOFC 30 to form CO and H₂ (syngas) in a 1:1 molar ratio. Additionally, in reaction (R12), H₂O(g) reacts with CH₄(g) to form CO and H₂ in a 1:3 molar ratio. The remainder of the CH₄ from the sweet gas in the first products stream 42 of the first SOFC 10 is electrochemically partially oxidized to CO and H₂ in a 1:2 molar ratio by O²⁻ ionic species producing electricity according to reaction (R13). Concurrently, a portion of the produced H₂ at the second anode 34 is electrochemically oxidized by O²⁻ as indicated in reaction (R14) and additionally contributing to the total electrical power outcome of the self-sustainable fuel cell system 5.

As with the first SOFC 10, the O²⁻ ionic species provided at the second anode 34 to allow reactions (R13) and (R14) are generated by O₂(g) in air according to reaction (R1). The O²⁻ ionic species are provided to the second anode 34 (fuel side) and the second solid electrolyte 36 from the second cathode 32 (air side). It will be appreciated that the first inlet air stream 80 and the second inlet air stream 84 may comprise air, pure oxygen, or other any oxygen containing gas stream.

Various metals suitable for oxidation may be utilized as the solid metal first anode 14 and the solid metal second anode 34, for example, a metal or metal ceramic. In one embodiment, the first anode 14, the second anode 34, or both comprises iron (Fe), cobalt (Co), nickel (Ni), copper (Cu) or combinations thereof. For the solid metal first anode 14 in the ex-situ SO₂ removal arrangement shown in FIG. 1 and the second anode 34 in both configurations shown in FIGS. 1 and 2, the metal selected for the anodes should be selected to maintain a solid phase at the SOFC operating temperature.

For the case of the first solid electrolyte 16 and the second solid electrolyte 36, high ionic conductivity and negligible chemical interactions with the first anode 14 and the second anode 34 respectively are required. That being said, various compositions are suitable for the first solid electrolyte 16 or the second solid electrolyte 36, with the major requirement being oxygen ion conductivity. Suitable solid electrolytes may be either purely ionic or mixed ionic-electronic.

For example, and not by way of limitation, the first solid electrolyte 16 or the second solid electrolyte 36 may comprise zirconia based electrolytes or ceria based electrolytes. In specific embodiments, the zirconia-based electrolyte may be selected from the group consisting of yttria stabilized ZrO₂ (YSZ), scandia stabilized ZrO₂ (ScSZ), calcia stabilized ZrO₂ (CSZ) and combinations thereof. In an exemplary embodiment, the first solid electrolyte 16 or the second solid electrolyte 36 may comprise yttria stabilized ZrO₂ (YSZ). Alternatively, the ceria-based electrolytes may comprise rare earth doped ceria. For example, the ceria-based electrolytes are selected from the group consisting of gadolinium doped ceria (GDC), yttria doped ceria (YDC), samarium doped ceria (SmDC), and combinations thereof.

When selecting the composition for the first solid electrolyte 16 or the second solid electrolyte 36, the following factors should be considered: possible chemical interactions with any of the electrodes, which may have a catastrophic effect on the fuel cell; the fuel cell operating temperature range; and the ionic/electronic conductivity ratio value. As a result, combinations of two or more solid electrolytes may be used to ensure these factors are met. For example, in cases where a non-stable solid electrolyte is necessary to be used in the fuel cell due to its remarkable ionic conductivity at the desired operating temperature, a thin coating of a chemically stable solid electrolyte may be used at the electrolyte and anode interface to avoid direct contact between the anode and the solid electrolyte. The same technique can be used to block the electronic conductivity that a highly conductive mixed ionic-electronic solid electrolyte may exhibit at the desired temperature range. In that instance, a thin coating of a purely ionic conductor such as YSZ may be beneficial.

On the other hand, any cathodic material that exhibits low O₂(g) reduction overpotential at the higher operating temperature range while having negligible interactions with the electrolyte could be used in the first cathode 12 and the second cathode 32. For example and not by way of limitation, the first cathode 12 or the second cathode 32 may comprise lanthanum strontium manganite (LS M), yttria stabilized ZrO₂/lanthanum strontium manganite (YSZ-LSM), lanthanum strontium cobalt ferrite (LSCF), and combinations thereof. In an exemplary embodiment, the first cathode 12 or the second cathode 32 may comprise lanthanum strontium manganite (LSM).

The combustion circuit 60 receives a second products stream 48 from the second SOFC 30. The second products stream 48 from the second SOFC 30 includes syngas (CO and H₂) as the product of reaction (R13). The second products stream 48 may additionally contain

H₂O as the product of reaction (R14). The feed of primarily syngas to the combustion circuit 60 is burned in the combustor 62 and converted to CO₂ and H₂O. The CO₂ and H₂O generated from burning the syngas in the second products stream 48 in the combustor 62 is merged with the first products stream 42 of the first SOFC 10. The combined stream is fed back into the second SOFC 30 as reactants for reactions (R11) and (R12) as the second SOFC feed stream 44. The burning in the combustor 62 generates heat which is transferred to the circulating heat carrier 64 for passage to the first SOFC 10 and the second SOFC 30.

The circulating heat carrier 64 may comprise any heat exchanger mechanism known to one having skill in the art. In at least one embodiment, the circulating heat carrier 64 comprises a series of fluid filled tubes which receive heat from the combustor 62 during passage through the flame or heated space of the combustor 62 and further are in thermal contact with the first SOFC 10 and second SOFC 30. The fluid filling the tubes of the circulating heat carrier 64 may be circulating to transfer the heat acquired from the combustor 62 to each of the first SOFC 10 and the second SOFC 30. The flow pattern of the fluid may be adjusted both in rate and route to maintain the first SOFC 10 at the first operating temperature and the second SOFC 30 at the second operating temperature. In various embodiments, the fluid in the circulating heat carrier 64 may be a brine solution or water, for example. The fluid in the circulating heat carrier 64 may be any components of gas, liquid or solid fine particles that can tolerate the operating temperature of the combustor 62.

In at least one embodiment, the self-sustainable SOFC system 5 comprises an external fuel supply 90 to the combustion circuit 60. The external fuel supply 90 provides combustible gases to the combustor 62 for initial start-up of the system 5. The external fuel supply 90 provides the fuel to allow the combustion circuit 60 to raise the first SOFC 10 to or toward the first operating temperature and the second SOFC 30 to or toward the second operating temperature for improved fuel cell operation before introduction of the sour gas feed 8 into the first SOFC 10. The system 5 may also include external heaters (not shown) or other devices to increase the temperature of the first SOFC 10, the second SOFC 30, or both before activation of the system 5 at initial start-up. In various embodiments, the external fuel supply 90 may comprise syngas, sweet gas, or combinations thereof.

In at least one embodiment, the SO₂ removed from the first SOFC 10 (in-situ or ex-situ configuration) by the SO₂ removal equipment 40 may be provided to further units for collection or for immediate further processing. For example, the SO₂ may be converted to SO₃ and subsequently to sulfuric acid for collection and utilization in various industrial applications. In further embodiments, the SO₂ may also be vented to the atmosphere.

The self-sustainable solid oxide fuel cell system 5 also contributes to the global efforts for managing CO₂ emissions by enhancing energy generation efficiency from natural gas as well as utilizing generated CO₂ emissions from the electricity generation process in a closed loop carbon cycle. Specifically, the dual steps of the system 5 where the H₂S is removed from the sour gas before passage to the second SOFC 30 for further electrochemical conversion and energy generation improves the overall efficiency of the system 5.

It should now be understood the various aspects of the self-sustainable solid oxide fuel cell system for powering a gas well and the method of generating electricity from sour natural gas are described and such aspects may be utilized in conjunction with various other aspects.

In a first aspect, the disclosure provides a self-sustainable solid oxide fuel cell (SOFC) system for powering a gas well. They system comprises a first SOFC having a first cathode, a first anode, and a first solid electrolyte disposed between the first cathode and the first anode. The system additionally comprises a second SOFC having a second cathode, a second anode, and a second solid electrolyte disposed between the second cathode and the second anode fluidly connected to a first products stream from the first SOFC. Further, the system comprises SO₂ removal equipment in fluid communication with the first SOFC to remove SO₂, a combustion circuit comprising a combustor and a circulating heat carrier fluidly connected to a second products stream from the second SOFC, and one or more external electric circuits connected to the first SOFC and the second SOFC. The first anode comprises a first oxidation region configured to produce SO₂ and electrons from H₂S in a natural gas feed stream. The second anode comprises a second oxidation region configured to electrochemically oxidize CH₄ in the first products stream to produce syngas and electrons and electrochemically oxidize H₂ to produce H₂O and electrons. The circulating heat carrier is in thermal connection with the combustor, the first SOFC, and the second SOFC such that heat generated in the combustor from combustion of at least the second products stream is distributed to the first SOFC to maintain the first SOFC at a first operating temperature and distributed to the second SOFC to maintain the second SOFC at a second operating temperature, the first and second operating temperatures in excess of 700° C. The external electric circuits are configured to generate power from the electrons produced in both the first SOFC and the second SOFC.

In a second aspect, the disclosure provides the system of the first aspect, in which the first anode and the second anode are solid metal anodes.

In a third aspect, the disclosure provides the system of the first or second aspects, in which the SO₂ removal equipment is disposed between the first SOFC and the second SOFC.

In a fourth aspect, the disclosure provides the system of any of the first through third aspects, in which the SO₂ removal equipment comprises a separating column or membrane.

In a fifth aspect, the disclosure provides the system of any of the first through fourth aspects, in which the first anode and the second anode comprise metals or metal-ceramics.

In a sixth aspect, the disclosure provides the system of any of the first through fifth aspects, in which the first anode and the second anode comprise metal selected from the group consisting of iron (Fe), copper (Cu), nickel (Ni), cobalt (Co), and combinations thereof.

In a seventh aspect, the disclosure provides the system of first aspect, in which the first anode is a molten metal anode.

In an eighth aspect, the disclosure provides the system of any of the seventh aspect, in which the self-sustainable SOFC system further comprises a molten metal conduit configured to circulate the molten metal of the first anode.

In a ninth aspect, the disclosure provides the system of the seventh or eighth aspects, in which the self-sustainable SOFC system further comprises a sulfation region configured to produce metal sulfides from metals in the first anode.

In a tenth aspect, the disclosure provides the system of eighth or ninth aspects, in which the sulfation region is disposed in the molten metal conduit.

In an eleventh aspect, the disclosure provides the system of the ninth or tenth aspects, in which the metal sulfides are electrochemical oxidized upon contact with the first solid electrolyte to produce SO₂ and electricity.

In a twelfth aspect, the disclosure provides the system of any of the ninth through eleventh aspects, in which the SO₂ removal equipment is disposed in the molten metal conduit between the first solid electrolyte and the sulfation region in the flow of the first anode and comprises a separating column or membrane.

In a thirteenth aspect, the disclosure provides the system of any of the seventh through twelfth aspects, in which the first anode comprises metal selected from the group consisting of tin (Sn), bismuth (Bi), indium (In), lead (Pb), antimony (Sb), copper (Cu), molybdenum (Mo), mercury (Hg), iridium (Ir), palladium (Pd), rhenium (Re), platinum (Pt), silver (Ag), arsenic (As), rhodium (Rh), tellurium (Te), selenium (Se), osmium (Os), gold (Au), germanium (Ge), thallium (Tl), cadmium (Cd), gadolinium (Gd), chromium (Cr), nickel (Ni), iron (Fe), tungsten (W), cobalt (Co), zinc (Zn), vanadium (V), and combinations thereof.

In a fourteenth aspect, the disclosure provides the system of any of the seventh through twelfth aspects, in which the first anode comprises antimony.

In a fifteenth aspect, the disclosure provides the system of any of the first through fourteenth aspects, in which the circulating heat carrier maintains the first operating temperature and the second operating temperature at 700° C. to 900° C.

In a sixteenth aspect, the disclosure provides the system of any of the first through fifteenth aspects, in which the first solid electrolyte, the second solid electrolyte, or both comprises zirconia-based electrolytes or ceria-based electrolytes.

In a seventeenth aspect, the disclosure provides the system of the sixteenth aspect, in which the zirconia-based electrolytes are selected from the group consisting of yttria stabilized ZrO₂ (YSZ), scandia stabilized ZrO₂ (ScSZ), calcia stabilized ZrO₂ (CSZ) and combinations thereof.

In an eighteenth aspect, the disclosure provides the system of the sixteenth aspect, in which the ceria-based electrolytes comprise rare earth doped ceria.

In a nineteenth aspect, the disclosure provides the system of any of the first through eighteenth aspects, in which the first solid electrolyte, the second solid electrolyte, or both comprise yttria stabilized ZrO₂ (YSZ).

In a twentieth aspect, the disclosure provides the system of any of the first through nineteenth aspects, in which the first cathode, the second cathode, or both is selected from the group consisting of lanthanum strontium manganite (LSM), yttria stabilized ZrO₂/lanthanum strontium manganite (YSZ-LSM), lanthanum strontium cobalt ferrite (LSCF), and combinations thereof.

In a twenty-first aspect, the disclosure provides the system of any of the first through twentieth aspects, in which the self-sustainable solid oxide fuel cell system further comprises an external fuel supply to the combustion circuit.

In a twenty-second aspect, the disclosure provides the system of the twenty-first aspect, in which the external fuel supply comprises syngas.

In a twenty-third aspect, the disclosure provides the system of the twenty-first aspect, in which the external fuel supply comprises sweet gas.

In a twenty-fourth aspect, the disclosure provides a method for generating electricity from sour natural gas. The method comprises providing a solid oxide fuel cell (SOFC) system. The SOFC system comprises a first SOFC comprising a first cathode, a first anode, and a first solid electrolyte disposed between the first cathode and the first anode; a second SOFC comprising a second cathode, a second anode, and a second solid electrolyte disposed between the second cathode and the second anode fluidly connected to a first products stream from the first SOFC; SO₂ removal equipment in fluid communication with the first SOFC to remove SO_{2;} a combustion circuit comprising a combustor and a circulating heat carrier fluidly connected to a second products stream from the second SOFC; and one or more external electric circuits connected to the first SOFC and the second SOFC. The method further comprises feeding the sour natural gas to the first SOFC; producing SO₂ and electrons from H₂S in the sour natural gas at a first oxidation region of the first anode; removing SO₂ from the system with the SO₂ removal equipment; feeding the first products stream from the first SOFC with the SO₂ removed to the second SOFC; electrochemically oxidizing CH₄ from the first products stream from the first SOFC in a second oxidation region of the second anode to produce syngas and electrons; feeding the second products stream from the second SOFC to the combustion circuit and burning the syngas in the combustor to generate heat; distributing the heat generated in the combustor to the first SOFC and the second SOFC via the circulating heat carrier; feeding a combustion product stream from the combustor to the second SOFC; and generating electricity with the one or more external electric circuits by collecting electrons generated in the first SOFC and the second SOFC.

In a twenty-fifth aspect, the disclosure provides the method of the twenty-fourth aspect, in which the method further comprises electrochemically oxidizing H₂ from the first products stream from the first SOFC in the second oxidation region of the second anode to produce H₂O and electrons.

In a twenty-sixth aspect, the disclosure provides the method of the twenty-fourth or twenty-fifth aspects, in which the first anode is a molten metal anode.

In a twenty-seventh aspect, the disclosure provides the method of the twenty-sixth aspect, in which producing SO₂ and electrons from H₂S in the sour natural gas comprises contacting the first anode with the H₂S from the sour natural gas to produce metal sulfides and oxidizing the metal sulfides in the first oxidation region to produce SO₂.

In a twenty-eighth aspect, the disclosure provides the method of the twenty-fourth or twenty-fifth aspects, in which the first anode is a solid metal anode.

In a twenty-ninth aspect, the disclosure provides the method of the twenty-eighth aspect, in which producing SO₂ and electrons from H₂S in the sour natural gas comprises directly oxidizing the H₂S from the sour natural gas to SO₂ in the first oxidation region.

It should be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A self-sustainable solid oxide fuel cell (SOFC) system for powering a gas well comprising:
a first SOFC comprising a first cathode, a first anode, and a first solid electrolyte disposed between the first cathode and the first anode;
a second SOFC comprising a second cathode, a second anode, and a second solid electrolyte disposed between the second cathode and the second anode fluidly connected to a first products stream from the first SOFC;
SO₂ removal equipment in fluid communication with the first SOFC to remove SO₂;
a combustion circuit comprising a combustor and a circulating heat carrier fluidly connected to a second products stream from the second SOFC; and
one or more external electric circuits connected to the first SOFC and the second SOFC, wherein
the first anode comprises a first oxidation region configured to produce SO₂ and electrons from H₂S in a natural gas feed stream;
the second anode comprises a second oxidation region configured to electrochemically oxidize CH₄ in the first products stream to produce syngas and electrons and electrochemically oxidize H₂ to produce H₂O and electrons;
the circulating heat carrier is in thermal connection with the combustor, the first SOFC, and the second SOFC such that heat generated in the combustor from combustion of at least the second products stream is distributed to the first SOFC to maintain the first SOFC at a first operating temperature and distributed to the second SOFC to maintain the second SOFC at a second operating temperature, the first and second operating temperatures in excess of 700° C.; and
the external electric circuits are configured to generate power from the electrons produced in both the first SOFC and the second SOFC.

2. The system of claim 1 wherein the first anode and the second anode are solid metal anodes.

3. The system of claim 1 wherein the SO₂ removal equipment is disposed between the first SOFC and the second SOFC.

4. The system of claim 1 wherein the first anode is a molten metal anode.

5. The system of claim 4 wherein the self-sustainable SOFC system further comprises a molten metal conduit configured to circulate the molten metal of the first anode.

6. The system of claim 5 wherein the self-sustainable SOFC system further comprises a sulfation region configured to produce metal sulfides from metals in the first anode.

7. The system of claim 6 wherein the metal sulfides are electrochemical oxidized upon contact with the first solid electrolyte to produce SO₂ and electricity.

8. The system of claim 6 wherein the SO₂ removal equipment is disposed in the molten metal conduit between the first solid electrolyte and the sulfation region in the flow of the first anode and comprises a separating column or membrane.

9. The system of claim 4 wherein the first anode comprises metal selected from the group consisting of tin (Sn), bismuth (Bi), indium (In), lead (Pb), antimony (Sb), copper (Cu), molybdenum (Mo), mercury (Hg), iridium (Ir), palladium (Pd), rhenium (Re), platinum (Pt), silver (Ag), arsenic (As), rhodium (Rh), tellurium (Te), selenium (Se), osmium (Os), gold (Au), germanium (Ge), thallium (Tl), cadmium (Cd), gadolinium (Gd), chromium (Cr), nickel (Ni), iron (Fe), tungsten (W), cobalt (Co), zinc (Zn), vanadium (V), and combinations thereof.

10. The system of claim 1 wherein the circulating heat carrier maintains the first operating temperature and the second operating temperature at 700° C. to 900° C.

11. The system of claim 1 wherein the first solid electrolyte, the second solid electrolyte, or both comprises zirconia-based electrolytes or ceria-based electrolytes.

12. The system of claim 1 wherein the first solid electrolyte, the second solid electrolyte, or both comprise yttria stabilized ZrO₂ (YSZ).

13. The system of claim 1 wherein the first cathode, the second cathode, or both is selected from the group consisting of lanthanum strontium manganite (LSM), yttria stabilized Zr0₂/lanthanum strontium manganite (YSZ-LSM), lanthanum strontium cobalt ferrite (LSCF), and combinations thereof.

14. The system of claim 1 wherein the self-sustainable solid oxide fuel cell system further comprises an external fuel supply to the combustion circuit.

15. A method for generating electricity from sour natural gas, the method comprising:
providing a solid oxide fuel cell (SOFC) system comprising
a first SOFC comprising a first cathode, a first anode, and a first solid electrolyte disposed between the first cathode and the first anode;
a second SOFC comprising a second cathode, a second anode, and a second solid electrolyte disposed between the second cathode and the second anode fluidly connected to a first products stream from the first SOFC;
SO₂ removal equipment in fluid communication with the first SOFC to remove SO₂;
a combustion circuit comprising a combustor and a circulating heat carrier fluidly connected to a second products stream from the second SOFC; and
one or more external electric circuits connected to the first SOFC and the second SOFC;
feeding the sour natural gas to the first SOFC;
producing SO₂ and electrons from H₂S in the sour natural gas at a first oxidation region of the first anode;
removing SO₂ from the system with the SO₂ removal equipment;
feeding the first products stream from the first SOFC with the SO₂ removed to the second SOFC;
electrochemically oxidizing CH₄ from the first products stream from the first SOFC in a second oxidation region of the second anode to produce syngas and electrons;
feeding the second products stream from the second SOFC to the combustion circuit and burning the syngas in the combustor to generate heat;
distributing the heat generated in the combustor to the first SOFC and the second SOFC via the circulating heat carrier;
feeding a combustion product stream from the combustor to the second SOFC; and
generating electricity with the one or more external electric circuits by collecting electrons generated in the first SOFC and the second SOFC.

16. The method of claim 15 wherein the method further comprises electrochemically oxidizing H₂ from the first products stream from the first SOFC in the second oxidation region of the second anode to produce H₂O and electrons.

17. The method of claim 15 wherein the first anode is a molten metal anode.

18. The method of claim 17 wherein producing SO₂ and electrons from H₂S in the sour natural gas comprises contacting the first anode with the H₂S from the sour natural gas to produce metal sulfides and oxidizing the metal sulfides in the first oxidation region to produce SO₂.

19. The method of claim 15 wherein the first anode is a solid metal anode.

20. The method of claim 19 wherein producing SO₂ and electrons from H₂S in the sour natural gas comprises directly oxidizing the H₂S from the sour natural gas to SO₂ in the first oxidation region.
